(19) United States
(12) Patent Application Publication
(10) Pub. No.: US 2015/0185724 A1
(43) Pub. Date: Jul. 2, 2015

(54) FACILITY CONTROLLING SYSTEM, CONTROLLER, DOWNLOADING METHOD, AND SOFTWARE CHANGING METHOD

(71) Applicant: AZBIL CORPORATION, Tokyo (JP)

(72) Inventor: Takashi NOGUCHI, Tokyo (JP)

(73) Assignee: AZBIL CORPORATION, Tokyo (JP)

(21) Appl. No.: 14/573,311

(22) Filed: Dec. 17, 2014

(30) Foreign Application Priority Data
Dec. 27, 2013 (JP) 2013-272158

(51) Int. Cl. G05B 15/02; G06F 9/445

(52) U.S. Cl. CPC G05B 15/02; G06F 8/60

(57) ABSTRACT

A controller includes: a controlling portion that monitors or controls a field instrument; a download buffer memory that saves settings data or software that has been downloaded; a program working memory that stores settings data or software that control the operation of the controlling portion; a deployment executing portion that deploys, into the program working memory, settings data or software that has been stored in the download buffer memory, when a designated scheduled time for deployment has arrived or when a deployment command message has been received; and an operating mode changing portion that switches to an offline mode when the scheduled time for deployment has arrived or when a deployment command message is received, and returns to the online mode after the deployment of the settings data or software to the program working memory has been completed.

### CROSS REFERENCE TO RELATED APPLICATION

This application claims priority under 35 U.S.C. §119 to Japanese Patent Application No. 2013-272158, filed on Dec. 27, 2013, the entire content of which being hereby incorporated herein by reference.

### FIELD OF TECHNOLOGY

The present invention relates to a technology for changing efficiently settings data or software for a controller for monitoring or controlling field instruments in a facility controlling system, or the like

### BACKGROUND

In order to carry out downloading of settings data, application software, or firmware for a field controller in a conventional building monitoring system, or the like, it is necessary to first switch the controller into an offline mode before carrying out the operation. This type of operation is normally carried out using an engineering tool that is connected to a network. However, when the controller is put into the offline mode, the air conditioning control is stopped, and a state wherein the field instruments the operations are not monitored is produced in a tenant building, and, in a plant, a state is produced wherein the operations are stopped. Because of this, for work using the engineering tool, often the work is requested late at night, or on holidays, when no one is in the facility.

In relation to this, in the control system network system disclosed in, for example, Japanese Unexamined Patent Application Publication No. 2001-333128 (“the JP '128”), each network instrument is provided with communication processing means and control processing means for which the operating modes can be changed independently of each other, so that when engineering work is performed wherein the engineering tool overwrites the communication parameters that are set in the network instrument, the operating mode of the communication processing means is changed to the offline mode to enable the communication parameters to be overwritten by carrying out the engineering work while still in an operating state, without stopping the control processing means that carry out the application operations such as control, and the like.

However, even in the control system network system disclosed in the JP '128, it is still necessary to put the communication processing means into the offline mode when carrying out the engineering work. Because of this, it becomes impossible to collect data for lower-level devices, and thus, for example, it is necessary for the operator to be aware of, and to avoid, work that would span over the scheduled time (such as XX:XX o'clock) at which daily report data is to be collected, which, in the case of a large-scale system wherein a large number of controllers are installed, may be difficult to accomplish in a single evening, even if the work is carried out by a large number of people.

The present invention was created in order to solve the problem set forth above, and an aspect thereof is to provide a facility controlling system, a controller, a downloading method, and a software changing method, wherein it is possible to change settings data and software for a controller efficiently.

### SUMMARY

A facility controlling system according to the present invention includes a controller that monitors or controls a field instrument, and an engineering device that is connected to the controller through a network.

The engineering device includes: download executing means for sending, to an aforementioned controller, settings data or software to be downloaded by the controller; deployment schedule designating means for sending, to the controller, a deployment schedule for deploying to the controller the settings data or software that has been downloaded; and deployment commanding means for sending, to the controller, a deployment command message for causing the downloaded settings data or software to be deployed to the controller.

The controller includes: controlling means for monitoring or controlling a field instrument; a download buffer memory for saving temporarily settings data or software that has been downloaded; a program working memory for storing settings data or software that control the operation of the controlling means; operating mode changing means for switching the controller from an online mode to an offline mode when the scheduled time for deployment arrives or when a deployment command message is received, and for returning the controller to the online mode after the deployment of the downloaded settings data or software to the program working memory has been completed; and deployment executing means for deploying, into the program working memory, settings data or software that has been downloaded from the engineering device and stored in the download buffer memory.

In one example configuration of a facility controlling system according to the present invention, the controller further includes: compatibility checking means for checking the compatibility of the settings data or software, prior to deployment of the downloaded settings data or software into the program working memory, and for reporting the compatibility check result to the engineering device; and deployment pass/fail checking means for checking whether or not the deployment of the downloaded settings data or software into the program working memory was successful, and for reporting the deployment a pass/fail check result to the engineering device.

Additionally, a controller according to the present invention includes: controlling means for monitoring or controlling a field instrument; a download buffer memory for saving temporarily settings data or software that has been downloaded from an engineering device through a network; a program working memory for storing settings data or software that control the operation of the controlling means; operating mode changing means for switching the controller from an online mode to an offline mode when a scheduled time for deployment, designated by the engineering device, arrives or when a deployment command message is received from the engineering device, and for returning the controller to the online mode after the deployment of the downloaded settings data or software to the program working memory has been completed; and deployment executing means for deploying, into the program working memory, settings data or software that has been downloaded from the engineering device and stored in the download buffer memory.

Additionally, a downloading method according to the present invention includes: a controlling step wherein a controller monitors or controls a field instrument following settings data or software that is stored in program working memory; a download executing step wherein an engineering device that is connected to a controller through a network sends, to the controller, settings data or software that is to be downloaded to the controller; a temporary storing step for storing, into a download buffer memory, settings data or software that has been downloaded; a deployment schedule designating step wherein the engineering device sends, to the controller, a deployment schedule for deploying to the controller the settings data or software that has been downloaded; a deployment commanding step wherein the engineering device sends, to the controller, a deployment command message for causing the downloaded settings data or software to be deployed to the controller; an offline mode switching step for switching the controller from an online mode to an offline mode at the scheduled deployment time or when a deployment command message has been received; a deployment executing step for deploying, into the program working memory, settings data or software that has been downloaded from the engineering device and stored in the download buffer memory; and an online mode switching step wherein the controller returns to the online mode after the completion of the deployment of the downloaded settings data or software to the program working memory has been completed.

Additionally, a software changing method for a controller according to the present invention includes: a controlling step for monitoring or controlling a field instrument following settings data or software that is stored in program working memory; a temporary storing step for saving temporarily, to a download buffer memory, settings data or software that has been downloaded from an engineering device through a network; an offline mode switching step for switching the controller from an online mode to an offline mode at a scheduled deployment time designated by the engineering device or when a deployment command message has been received from the engineering device; a deployment executing step for deploying, into the program working memory, settings data or software that has been downloaded from the engineering device and stored in the download buffer memory; and an online mode switching step for returning the controller to the online mode after the completion of the deployment of the downloaded settings data or software to the program working memory has been completed.

In the present invention, a download buffer memory is provided in the controller separate from the program working memory, thus enabling an operation for downloading settings data or software to the controller to be completed entirely during hours wherein it is necessary for the controller to be able to operate in the online mode. Given this, the downloaded settings data or software can be deployed to the controller, either through designating, as a scheduled deployment time at which the controller can be switched to the offline mode, or through sending a deployment command message at a time wherein the controller can be switched to the offline mode, thus enabling a large reduction in the work by the work floor operators in relation to the engineering work, and enabling the settings data and software for the controller to be changed efficiently.

Moreover, the present invention, through the controller checking the compatibility of the downloaded settings data or software, makes it possible to prevent, prior to deployment of the settings data or software into the program working memory, the occurrence of malfunctions after deployment. Furthermore, the present invention, through the provision of deployment pass/fail checking means in the controller, enables the operator to check whether or not the settings data or software were deployed successfully into the program working memory and the engineering work is complete. The result is that the present invention is able to reduce even further the labor by the work floor operator.

### BRIEF DESCRIPTIONS OF THE DRAWINGS

FIG. 1 is a block diagram illustrating a structure of a facility controlling system according to an example according to the present invention.

FIG. 2 is a flowchart for explaining the operation of an engineering device according to an example according to the present invention.

FIG. 3 is a flowchart for explaining the operation of a controller according to an example according to the present invention.

### DETAILED DESCRIPTION

### Example

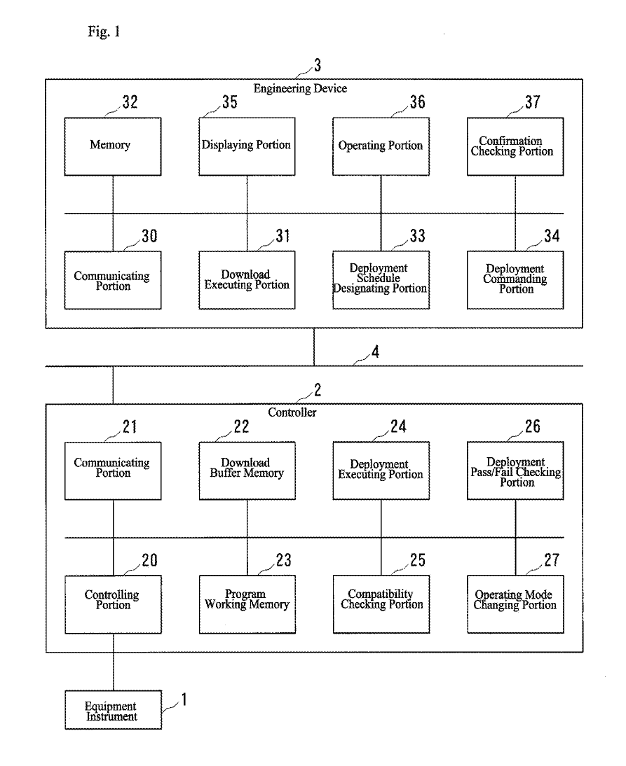

Forms for carrying out the present disclosure will be explained below in reference to the figures. FIG. 1 is a block diagram illustrating a configuration of a facility controlling system according to an example according to the present disclosure. The facility controlling system according to the present example is applied to, for example, a building controlling system or a plant controlling system, and is structured from a field instrument 1 such as a sensor or actuator (for example, a light, a switch, a motor, or the like), a controller 2 for monitoring or controlling the field instrument 1, an engineering device 3 for carrying out engineering work for the controller 2, and a network 4 for connecting together the controller 2 and the engineering device 3. Note that while in the example in FIG. 1 there is only a single controller 2, a plurality of controllers 2 may be connected instead to the network 4.

The controller 2 comprises: a controlling portion 20 for monitoring or controlling the field instrument 1; a communication portion 21 for communicating with an engineering device 3; a download buffer memory 22 for storing temporarily settings data or software (such as application software, firmware, or the like) that is downloaded from the engineering device 3; a program working memory 23 for storing settings data and software that control the operation of the controlling portion 20 and for storing data collected by the controlling portion 20 from the field instrument 1; a deployment executing portion 24 for deploying, into the program working memory 23, settings data or software that has been downloaded from the engineering device 3 and stored into the download buffer memory 22 when the controller 2 has switched into the offline mode when the scheduled deployment time designated by the engineering device has been reached or when a deployment command message has been received from the engineering device; a compatibility checking portion 25 for checking, prior to deployment of the downloaded settings data or software into the program working memory 23, the compatibility of the settings data or software and for reporting the compatibility check result to the engineering device 3; a deployment pass/fail checking portion 26 for checking whether or not the deployment of the downloaded settings data or software into the program working memory 23 was successful and for reporting the deployment pass/fail check results to the engineering device 3; and an operating mode changing portion 27 for switching the controller 2 from the online mode to the offline mode when the scheduled deployment time, designated by the engineering device 3, has been reached or when a deployment command message has been received from the engineering device 3, and for switching the controller 2 back to the online mode after completion of the deployment of the downloaded settings data or software into the program working memory 23.

The engineering device 3 comprises: a communication portion 30 for carrying out communication with the controller 2; a download executing portion 31 for sending, to the controller 2, the settings data or software that is to be downloaded to the controller 2; a memory 32 for storing software for controlling the operation of the engineering device 3 and settings data and software to be downloaded to the controller 2; a deployment schedule designating portion 33, for sending, to the controller 2, a deployment schedule for deploying the downloaded settings data or software into the controller 2; a deployment commanding portion 34 for sending a deployment command message to the controller 2 when it is time for the downloaded settings data or software to be deployed into the controller 2; a displaying portion 35 for displaying information to the operator; an operating portion 36 by which the operator inputs instructions into the engineering device 3; and a check confirming portion 37 for sending, to the controller 2, a confirmation check message that the deployment pass/fail check result has been confirmed.

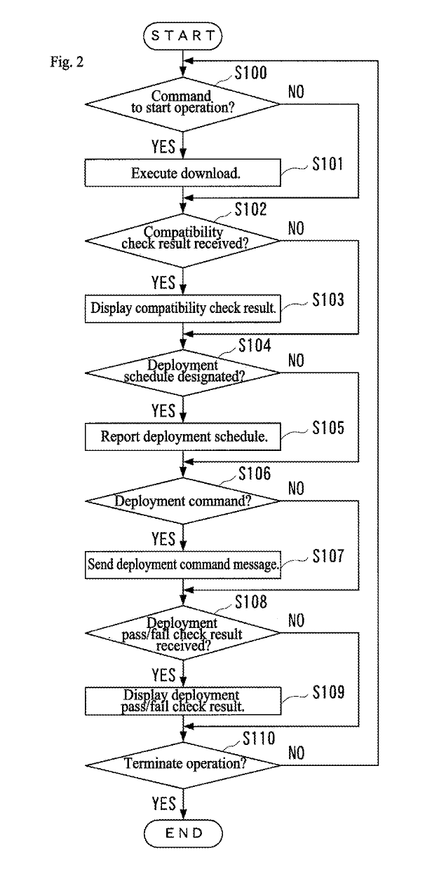

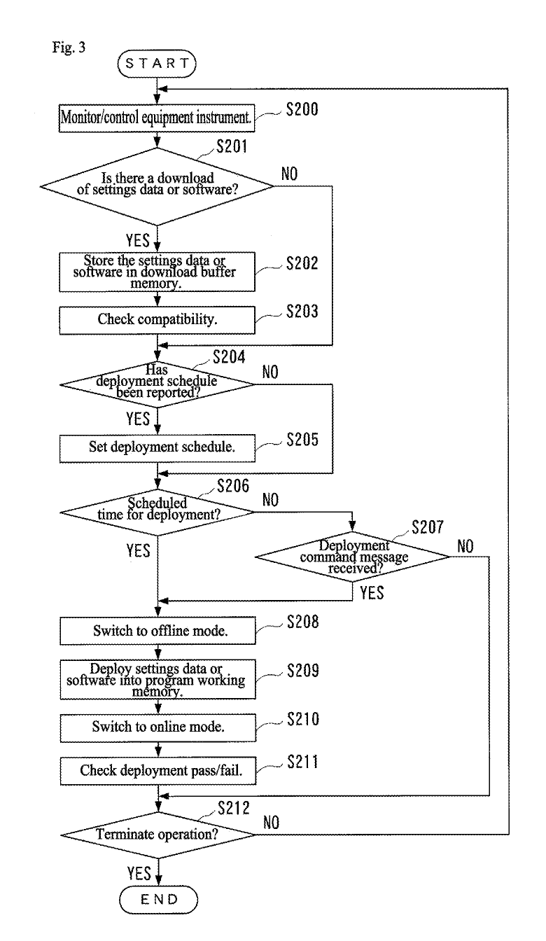

The operation of the facility controlling system according to the present example will be explained next. FIG. 2 is a flowchart for explaining the operation of the engineering device 3, and FIG. 3 is a flowchart for explaining the operation of the controller 2.

The controlling portion 20 of the controller 2 operates following the settings data and software that are stored in the program working memory 23, to monitor and/or control the field instrument 1 (Step S200 in FIG. 3). The controlling portion 20 stores, into the program working memory 23, data collected from the field instrument 1. Additionally, the controlling portion 20, as required, sends, to a higher-level device, data such as the operating history, daily report data, monthly report data, warning data, and the like, for the field instrument 1, through the communication portion 21.

When engineering work for changing the settings data or software in the controller 2 is required, for reasons such as an addition, change, or deletion of a field instrument 1 that is connected to the controller 2, for example, or the addition, change, or deletion of a monitoring point, and that there is a command to commence engineering work (YES in Step S100 in FIG. 2), the download executing portion 31 in the engineering device 3 reads out, from the memory 32, the settings data or software that is designated in advance to be downloaded to the controller 2, and sends this settings data or software through the communication portion 30 to the controller 2 (Step S101 in FIG. 2). At this time, there is no need to switch the controller 2 from the online mode, for normal operations, into the offline mode, for overwriting the settings data or software. Note that the settings data or software that is to be downloaded is generated and stored in the memory 32 in advance based on instructions from an operator.

Upon receipt of the downloaded settings data or software from the engineering device 3 (YES in Step S201 in FIG. 3), the communication portion 21 of the controller 2 stores to the received settings data or software into the download buffer memory 22 (Step S202 in FIG. 3).

The compatibility checking portion 25 of the controller 2 checks the compatibility of the settings data or software that has been downloaded from the engineering device 3 and stored into the download buffer memory 22, and reports the compatibility check result to the engineering device 3 (Step S203 in FIG. 3). Specifically, the compatibility checking portion 25 checks the compatibility of the settings data or software through not only checking the values that are written in the settings data or software, but through checking also whether or not the settings data or software has been generated in accordance with a requirement specification that has been established in advance. Such a compatibility checking technology is disclosed in, for example, Japanese Unexamined Patent Application Publication 2011-97430.

Upon receipt of the compatibility check result from the controller 2 (YES in Step S102 in FIG. 2), the communication portion 30 of the engineering device 3 sends the compatibility check result to the displaying portion 35. The displaying portion 35 displays the compatibility check result (Step S103 in FIG. 2). The controller 2 checking the compatibility of the downloaded settings data or software in this way makes it possible to prevent, prior to the deployment of the settings data or software into the program working memory 23, malfunctions that would occur after deployment.

Next, if an operator has designated a deployment schedule for deploying, to the program working memory 23 of the controller 2, the settings data or software that has been downloaded to the controller 2 (YES in Step S104 in FIG. 2), then the deployment schedule designating portion 33 of the engineering device 3 sends the deployment schedule to the controller 2 (Step S105 in FIG. 2). It is necessary to put the controller 2 into the offline mode in order to deploy the downloaded settings data or software into the program working memory 23. Consequently, the scheduled deployment time must be at a time wherein the facility controlling system is not operating, at, for example, 2:10 AM, or the like.

Upon receipt of the transmission of the deployment schedule from the engineering device 3 (YES in Step S204 in FIG. 3), the communication portion 21 of the controller 2 stores, in the program working memory 23, information indicating the deployment schedule (Step S205 in FIG. 3).

Note that rather than sending a deployment schedule to the controller 2 in advance, a deployment command message may be sent to the controller 2 when it is time to deploy the downloaded settings data or software into the program working memory 23 of the controller 2. That is, when there is a deployment command from an operator (Step S106 in FIG. 2), the deployment commanding portion 34 of the engineering device 3 sends a deployment command message to the controller 2 (Step S107 in FIG. 2).

Following this, when the scheduled deployment time, designated in advance by the engineering device 3, has been reached (YES in Step S206 in FIG. 3), or when a deployment command message has been received from the engineering device 3 (YES in Step S207 in FIG. 3), the operating mode changing portion 27 of the controller 2 switches the controller 2 from the online mode, for normal operations, to the offline mode, for overwriting the settings data and software (Step S208 in FIG. 3).

When the scheduled deployment time that has been designated in advance has been reached, or a when deployment command message has been received from the engineering device 3, and the controller 2 is switched into the offline mode, the deployment executing portion 24 of the controller 2 deploys (copies), into the program working memory 23, the settings data or software that has been downloaded from the engineering device 3 and stored in the download buffer memory 22 (Step S209 in FIG. 3). The settings data or software that is stored in the program working memory 23 is changed through being overwritten in this way. Following this, the operating mode changing portion 27 returns the controller 2 back to the online mode (Step S210 in FIG. 3).

The deployment pass/fail checking portion 26 of the controller 2 checks whether or not the deployment of the settings data or software into the program working memory 23 was successful, and reports the deployment pass/fail check result to the engineering device 3 (Step S211 in FIG. 3).

Upon receipt of the deployment pass/fail check result from the controller 2 (YES in Step S108 in FIG. 2), the communication portion 30 of the engineering device 3 sends the deployment pass/fail check result to the displaying portion 35. The displaying portion 35 displays the deployment pass/fail check result (Step S109 in FIG. 2). This enables the operator to confirm that the deployment of the settings data or software to the program working memory 23 was successful, and that the engineering work is complete.

Note that although in the present example the deployment pass/fail check result is recorded automatically to the engineering device 3, there is no limitation thereto, and instead the configuration may be one wherein a check confirming portion 37 of the engineering device 3 sends a confirmation message to the controller 2, and, in response to this confirmation message, the deployment pass/fail checking portion 26 of the controller 2 reports the deployment pass/fail check result to the engineering device 3.

Until the operation of the engineering device 3 is stopped (YES in Step S110 in FIG. 2), the engineering device 3 carries out the processes in Step S100 through S109 as necessary, and until the operation of the controller 2 is stopped (YES in Step S212 in FIG. 3), the controller 2 carries out the processes in Step S200 through S211 as necessary.

As described above, the present example, through the provision of a download buffer memory 22 that is separate from the program working memory 23 in the controller 2, enables the operation for downloading the settings data or software to the controller 2 to be completed entirely during hours wherein it is necessary to allow the controller 2 to operate in the online mode (for example, during working hours in a facility that is a tenant building, or the like). This enables the downloaded settings data or software to be deployed in the controller 2, through designating, and as a deployment schedule, a time wherein the controller 2 may be switched into the offline mode (for example, a time that is late at night), or through sending a deployment command message at a time wherein the controller 2 can be switched to the offline mode (for example, when all personnel have exited the facility), thus enabling a large reduction in the work by the work floor operator in relation to engineering work, and enabling the settings data and software in the controller 2 to be changed efficiently. The provision of the compatibility checking portion 25 and the deployment pass/fail checking portion 26 in the controller 2 enables a further reduction in the work by the work floor operator.

The controller 2 and the engineering device 3, described in the present example, may each be achieved through respective computers that are each equipped with a CPU (a central processing unit), a memory, and an interface, and through a program for controlling these hardware resources. The CPUs of the respective devices follow programs stored in the memories to execute the processes described in the present example.

The present invention can be applied to a technology for changing settings data and software and controllers that monitor or control field instruments in facilities controlling systems.

1. A facility controlling system comprising:
a controller that either monitors or controls a field instrument; and
an engineering device connected to the controller through a network, wherein:
the engineering device comprises:
a download executing portion that sends, to an aforementioned controller, either settings data or software to be downloaded by the controller;
a deployment schedule designating portion that sends, to the controller, a deployment schedule for deploying to the controller either the settings data or software that has been downloaded; and
a deployment commanding portion that sends, to the controller, a deployment command message for causing either the downloaded settings data or software to be deployed to the controller; and
the controller comprises:
a controlling portion that either monitors or controls a field instrument;
a download buffer memory that saves temporarily either settings data or software that has been downloaded;
a program working memory that stores either settings data or software that control the operation of the controlling portion;
an operating mode changing portion that switches the controller from an online mode to an offline mode either when the scheduled time for deployment arrives or when a deployment command message is received, and returns the controller to the online mode after the deployment of either the downloaded settings data or software to the program working memory has been completed; and
a deployment executing portion that deploys, into the program working memory, either settings data or software that has been downloaded from the engineering device and stored in the download buffer memory.

2. The facility controlling system as set forth in claim 1, wherein:
the controller further comprises:
a compatibility checking portion that checks the compatibility of either the settings data or software, prior to deployment of either the downloaded settings data or software into the program working memory, and reports the compatibility check result to the engineering device; and
a deployment pass/fail checking portion that checks whether or not the deployment of either the downloaded settings data or software into the program working memory was successful, and reports the deployment a pass/fail check result to the engineering device.

3. A controller comprising:
a controlling that either monitors or controls a field instrument;
a download buffer memory that saves temporarily either settings data or software that has been downloaded from an engineering device through a network;
a program working memory that stores either settings data or software that control the operation of the controlling portion;
an operating mode changing portion that switches the controller from an online mode to an offline mode either when a scheduled time for deployment, designated by the engineering device, arrives or when a deployment command message is received from the engineering device, and returns the controller to the online mode after the deployment of either the downloaded settings data or software to the program working memory has been completed; and
a deployment executing portion that deploys, into the program working memory, either settings data or software that has been downloaded from the engineering device and stored in the download buffer memory.

4. The controller as set forth in claim 3, further comprising:
a compatibility checking portion that checks the compatibility of either the settings data or software, prior to deployment of either the downloaded settings data or software into the program working memory, and reports the compatibility check result to the engineering device; and
a deployment pass/fail checking portion that checks whether or not the deployment of either the downloaded settings data or software into the program working memory was successful, and reports the deployment a pass/fail check result to the engineering device.

5. A downloading method comprising:
a controlling step wherein a controller either monitors or controls a field instrument following either settings data or software that is stored in program working memory;
a download executing step wherein an engineering device that is connected to a controller through a network sends, to the controller, either settings data or software that is to be downloaded to the controller;
a temporary storing step for storing, into a download buffer memory, either settings data or software that has been downloaded;
a deployment schedule designating step wherein the engineering device sends, to the controller, a deployment schedule for deploying to the controller either the settings data or software that has been downloaded;
a deployment commanding step wherein the engineering device sends, to the controller, a deployment command message for causing either the downloaded settings data or software to be deployed to the controller;
an offline mode switching step for switching the controller from an online mode to an offline mode either at the scheduled deployment time or when a deployment command message has been received;
a deployment executing step for deploying, into the program working memory, either settings data or software that has been downloaded from the engineering device and stored in the download buffer memory; and
an online mode switching step wherein the controller returns to the online mode after the completion of the deployment of either the downloaded settings data or software to the program working memory has been completed.

6. The downloading method as set forth in claim 5, further comprising:
a compatibility checking step wherein a controller checks the compatibility of either the settings data or software, prior to deployment of either the downloaded settings data or software into the program working memory, and reports the compatibility check result to the engineering device; and
a deployment pass/fail checking step wherein the controller checks whether or not the deployment of either the downloaded settings data or software into the program working memory was successful, and reports the deployment a pass/fail check result to the engineering device.

7. A controller software changing method, comprising:
a controlling step for either monitoring or controlling a field instrument following either settings data or software that is stored in program working memory;
a temporary storing step for saving temporarily, to a download buffer memory, either settings data or software that has been downloaded from an engineering device through a network;
an offline mode switching step for switching the controller from an online mode to an offline mode either at a scheduled deployment time designated by the engineering device or when a deployment command message has been received from the engineering device;
a deployment executing step for deploying, into the program working memory, either settings data or software that has been downloaded from the engineering device and stored in the download buffer memory; and
an online mode switching step for returning the controller to the online mode after the completion of the deployment of either the downloaded settings data or software to the program working memory has been completed.

8. The controller software changing method as set forth in claim 7, further comprising:
a compatibility checking step for checking the compatibility of either the settings data or software, prior to deployment of either the downloaded settings data or software into the program working memory, and for reporting the compatibility check result to the engineering device; and
a deployment pass/fail checking step for checking whether or not the deployment of either the downloaded settings data or software into the program working memory was successful, and for reporting the deployment a pass/fail check result to the engineering device.
